(19) United States
(12) Patent Application Publication
(10) Pub. No.: US 2013/0031409 A1
(43) Pub. Date: Jan. 31, 2013

(54) DEVICE AND METHOD FOR TESTING A MEMORY OF AN ELECTRIC TOOL

(71) Applicant: Wolfgang BECK, Schongau (DE)

(72) Inventor: Wolfgang BECK, Schongau (DE)

(73) Assignee: Hilti Aktiengesellschaft, Schaan (LI)

(21) Appl. No.: 13/550,070

(22) Filed: Jul. 16, 2012

(30) Foreign Application Priority Data
Jul. 26, 2011 (DE) DE102011079779.3

(51) Int. Cl. G06F 11/28

(52) U.S. Cl. 714/27; 714/E11.178

(57) ABSTRACT

The device for testing a memory of an electric tool has a memory, a control unit for controlling the electric tool and a testing module. The memory has a plurality of memory cells for storing data, a first interface and a second interface that is independent of the first interface. The control unit is coupled to the memory via the first interface. The testing module is configured for testing the memory cells of the memory and for this purpose, it is coupled to the memory via the second interface. A tool and method are also provided.

This claims the benefit of German Patent Application DE 10 2011 079 779.3. filed Jul. 26, 2011 and hereby incorporated by reference herein.

The present invention relates to a device and to a method for testing a memory of an electric tool. The memory is, for example, a RAM memory (RAM: Random Access Memory) and the electric tool is, for example, a hand-held power tool, especially an electric hand-held power tool, such as, for instance, an electric screwdriver.

Memory tests such as, for example, cyclic RAM tests are required within the scope of various standards for providing functionally reliable software. An example of such a standard is IEC 60730. According to this standard, faulty memory cells have to be detected. After a faulty memory cell has been detected, appropriate safety measures or emergency measures can be initiated.

Within the scope of such RAM tests, various test sequences are written into a RAM cell, read back and checked for correctness. These memory tests are normally performed by the control unit of the electric tool, especially by the software implemented on the control unit. Such a control unit is, for example, a microcontroller or a CPU (CPU: Central Processing Unit).

### SUMMARY OF THE INVENTION

Thus, it is a drawback that a certain amount of implementation work is needed for the memory test by the software of the control unit. Moreover, the control unit of the electric tool is occupied while the memory test is being performed and, at least at certain times, can even be blocked. Furthermore, it is a drawback that it might be necessary to block interrupts in order to for the memory test to be performed.

It is an object of the present invention to provide a device for testing a memory of an electric tool that has a memory, a control unit for controlling the electric tool and a testing module. The memory has a plurality of memory cells for storing data, a first interface and a second interface that is independent of the first interface. The memory is, for example, a RAM memory or a FLASH drive. The control unit is coupled, especially connected, to the memory via the first interface. The testing module is configured for testing the memory cells of the memory and for this purpose, it is coupled, especially connected, to the memory via the second interface.

The present invention provides that there is no need for the usual implementation work for the memory test in the software of the control unit. The control unit is alleviated since there is a dedicated testing module. Furthermore, thanks to the dedicated testing module, the operation of the control unit is not blocked at any point in time, since the control unit accesses the memory via the first interface, whereas the testing module accesses the memory via the second interface. Interrupts also remain possible at all times.

The memory cell can have any desired word size, e.g. 1 bit, 4 bit, 8 bit, 16 bit, etc. The control unit can be configured as a microcontroller or as a CPU of the electric tool. The interface in question is, for example, an interface device or a port.

In one embodiment, the control unit is configured to access the memory via the first interface, whereas the testing module is configured to simultaneously access the memory via the second interface.

The possibility of being able to access the memory simultaneously ensures that the control unit is not blocked at any point in time during a memory test.

In another embodiment, the control unit and the testing module are integrated on a single integrated circuit, especially on a chip.

In another embodiment, the testing module and the memory are integrated on a single integrated circuit.

In another embodiment, the control unit, the testing module and the memory are integrated on a single integrated circuit.

In another embodiment, the testing module is configured to cyclically test the memory cells of the memory via the second interface.

In this manner, automated cyclical memory tests are made possible such as, for example, cyclical RAM tests for microcontroller systems.

In another embodiment, the testing module for testing a specific memory cell of the memory cells of the memory is configured to store in a buffer memory the data that is stored in the specific memory cell, to write a test sequence into the specific memory cell via the second interface, to read the test sequence that is stored in the specific memory cell, and to write the data that is stored in the buffer memory back into the specific memory cell.

The testing module can select the test sequence from an array of predefined test sequences.

The buffer memory can be implemented as part of the memory. As an alternative or in addition, the buffer memory can be implemented as part of the testing module.

In another embodiment, the testing module is configured to obtain a test result as a function of the test sequence read out of the specific memory cell, and to transmit the obtained test result to the control unit.

In order to determine the test result, the testing module will especially compare the test sequence read out of the specific memory cell to the test sequence that was written into the specific memory cell.

In another embodiment, the control unit is configured to carry out a safety measure in order to ensure the system safety as a function of the test result transmitted by the testing module.

In another embodiment, if a specific test result is present, the control unit selects a specific safety measure from a plurality of predefined safety measures and subsequently carries them out.

The plurality of predefined safety measures comprises, for example, de-energizing the device, switching the device to be voltage-free, and/or safely shutting down the device.

Furthermore, an electric tool with a memory is disclosed that has a device for testing a memory of the type described above according to the invention.

The electric tool is, for example, a hand-held power tool or an accumulator for a hand-held power tool. The hand-held power tool is especially an electric hand-held power tool such as, for example, an electric screwdriver.

The electric screwdriver has a housing with a handle by means of which a user can hold and guide the electric screwdriver. A pushbutton on the handle allows the user to put the electric screwdriver into operation. For example, the user has to continuously depress the push-button in order to keep the electric screwdriver in operation.

The electric screwdriver has a tool socket into which the user can insert a screw bit. When the push-button is actuated, an electric motor rotates the tool socket around its axis. The electric motor is coupled to the tool socket via a spindle and optionally via additional components of a drive train such as, for example, a clutch or gears.

Furthermore, a method for testing a memory of an electric tool is disclosed, said memory having a plurality of memory cells for storing data, a first interface and a second interface that is independent of the first interface, and said memory being coupled via the first interface to a control unit for controlling the electric tool. In a first step, the testing module is coupled, especially connected, to the memory via the second interface. In a second step, the memory cells of the memory are tested by means of the testing module that is coupled via the second interface.

### BRIEF DESCRIPTION OF THE DRAWINGS

The description below explains the invention on the basis of embodiments and figures shown by way of an example. The figures show the following:

FIG. 1 a schematic block diagram of an embodiment of a device for testing a memory of an electric tool;

FIG. 2 a schematic block diagram of an embodiment of an electric tool; and

FIG. 3 a schematic flow diagram of a method for testing a memory of an electric tool.

Unless otherwise indicated, identical elements or elements having the same function are designated in the figures with the same reference numerals.

### DETAILED DESCRIPTION

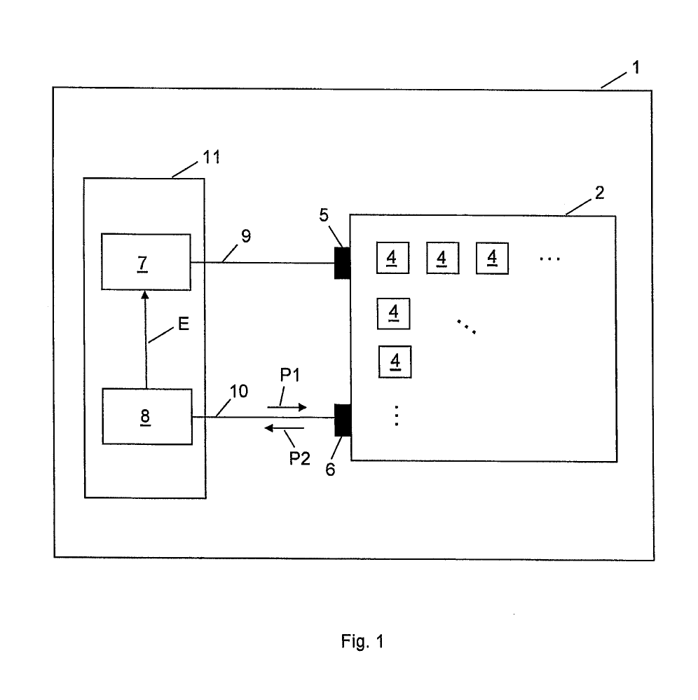

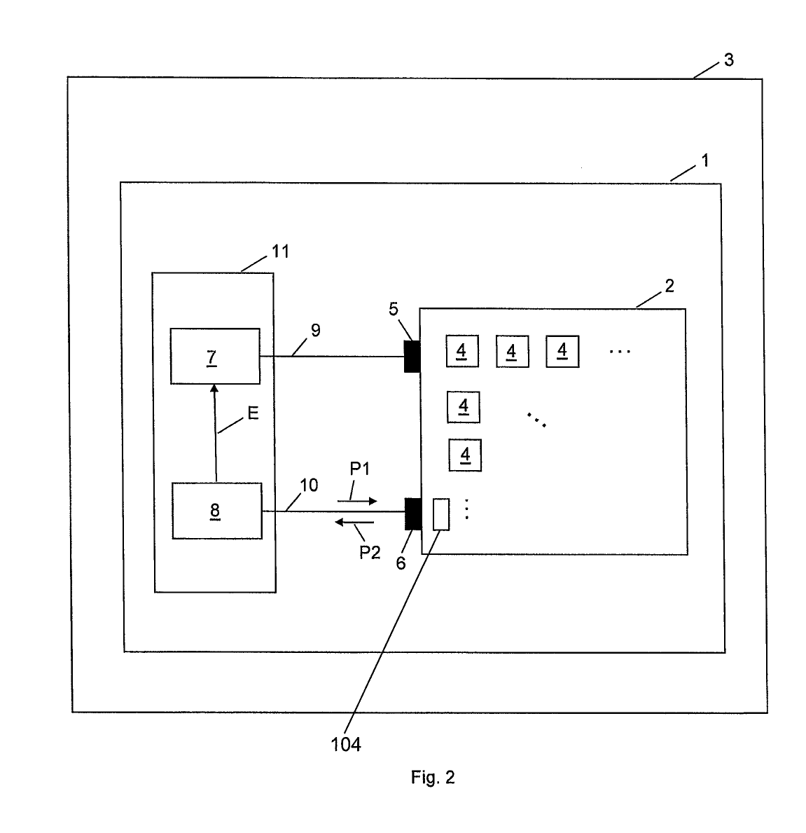

FIG. 1 shows a schematic block diameter of an embodiment of a device 1 for testing a memory 2 of an electric tool 3 (see FIG. 2).

The device 1 has the memory 2 that comprises a plurality of memory cells 4 for storing data. The memory 2 has a number N of memory cells. Without limiting the general applicability, FIG. 1 shows five memory cells 4. The memory 2 is, for example, a RAM memory. Moreover, the memory 2 has a first interface 5 and a second interface 6 that is independent of the first interface 5. The interfaces 5, 6 are configured, for example, as ports that can be actuated separately. The memory cells 4 of the memory 2 can be accessed externally via the first interface 5 or via the second interface 6.

A control unit 7 for controlling the electric tool 3 is connected to the memory 2 via the first interface 5. A first bus 9 or a communication bus, for example, is provided in order to connect the first interface 5 to the control unit 7.

A testing module 8 is connected to the memory 2 via the second interface 6. A second bus 10 or communication bus is provided in order to connect the second interface 6 to the testing module 8.

The control unit 7 and the testing module 8 are preferably integrated on an integrated circuit 11.

The testing module 8 is configured to cyclically test the memory cells 4 of the memory 2 via the second interface 6. Consequently, the N memory cells 4 of the memory are tested one after the other. After the testing of the N^{th} memory cell 4, the testing starts again with the first memory cell 4. In order to test a specific memory cell 4 of the memory 2, the data stored in this specific memory cell 4 is temporarily stored in a buffer memory, shown schematically as 104. Subsequently, the testing module 8 writes a test sequence P1 into the specific memory cell 4 at least once via the second interface 6. After a predefined period of time has elapsed, the test sequence P2 stored in the specific memory cell 4 is read out by the testing module 8 via the second interface 6. The original data of the specific memory cell 4 that had been temporarily stored in the buffer memory is written back into the specific memory cell 4.

By comparing the written test sequence P1 to the read-out test sequence P2, the testing module 8 can obtain a test result E. As a function of the difference ascertained between the read-out test sequence P2 and the written test sequence P2, the testing module 8 can preferably determine the type and scope of the fault in the specific memory cell 4. The type and scope of the specific fault can be part of the test result E.

The testing module 8 is also configured to transmit the specific test result E to the control unit 7. In particular, the testing module 8 is configured to listen in to the first interface 5 or to the first bus 9 to ascertain whether the specific memory cell 4 is being read or written by the control unit 7 during an ongoing test. In this case, the testing module 8 makes the data stored in the buffer memory available to the control unit 7.

The control unit 7 is preferably configured to carry out a safety measure in order to ensure the system safety as a function of the test result E transmitted by the testing module 8. Especially as a function of the specific type and specific scope of a fault ascertained in the specific memory cell 4, the control unit 7 is configured to select a specific safety measure from a plurality of predefined safety measures and to subsequently carry it out. For example, if a specific fault is ascertained, the device 1 is de-energized. As an alternative, the device 1 can also be shut down.

FIG. 2 shows a schematic block diagram of an embodiment of an electric tool 3. The electric tool 3 has the device 1 of FIG. 1. The electric tool 3 is, for example, a hand-held power tool such as an electric screwdriver, a power drill, a hammer drill, or an angle grinder. The electric tool 3 can also be an accumulator for a hand-held power tool.

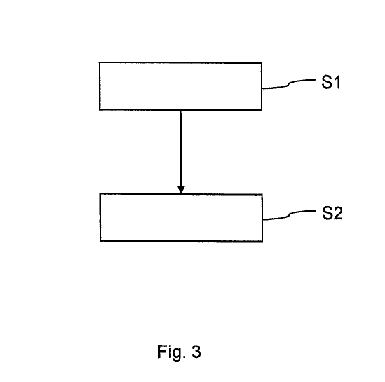

FIG. 3 shows a schematic flow diagram of a method for testing a memory 2 of an electric tool 3. The memory 2 has a plurality of memory cells 4 for storing data, a first interface 5 and a second interface 6 that is independent of the first interface 5. The memory 2 is coupled, especially connected, to a control unit 7 via the first interface 5 in order to control the electric tool.

In Step S1, a testing module 8 is coupled, especially connected to the memory 2 via the second interface 6.

In Step S2, the memory cells 4 of the memory are tested by means of the testing module 8 that is coupled via the second interface 6.

What is claimed is:

1. A device for testing a memory of an electric tool, the memory having a plurality of memory cells for storing data, a first interface and a second interface independent of the first interface, the device comprising:
a control unit for controlling the electric tool, the control unit being coupled to the memory via the first interface; and
a testing module for testing the memory cells of the memory, the testing module being coupled to the memory via the second interface.

2. The device as recited in claim 1 wherein the control unit is configured to access the memory via the first interface, and the testing module is configured to simultaneously access the memory via the second interface.

3. The device as recited in claim 1 wherein the control unit and the testing module are integrated on an integrated circuit.

4. The device as recited in claim 1 wherein the testing module is configured to cyclically test the memory cells of the memory via the second interface.

5. The device as recited in claim 1 wherein the testing module for testing a specific memory cell of the memory cells is configured to store in a buffer memory the data stored in the specific memory cell, to write a test sequence into the specific memory cell via the second interface, to read the test sequence stored in the specific memory cell, and to write the data stored in the buffer memory back into the specific memory cell.

6. The device as recited in claim 5 wherein the testing module is configured to obtain a test result as a function of the test sequence read out of the specific memory cell, and to transmit the obtained test result to the control unit.

7. The device as recited in claim 6 wherein the testing module is configured to obtain the test result by comparing the test sequence read out of the specific memory cell to the test sequence written into the specific memory cell.

8. The device as recited in claim 6 wherein the control unit is configured to carry out a safety measure in order to ensure the system safety as a function of the test result transmitted by the testing module.

9. The device as recited in claim 8 wherein, if a specific test result is present, the control unit is configured to select a specific safety measure from a plurality of predefined safety measures and to carry out the specific safety measure.

10. The device as recited in claim 9 wherein the plurality of predefined safety measures comprises at least one of de-energizing the device, switching the device to be voltage-free, and safely shutting down the device.

11. The device as recited in claim 1 wherein the memory is a RAM memory or a FLASH drive.

12. An electric tool comprising the device as recited in claim 1.

13. The electric tool as recited in claim 12 wherein the electric tool is a hand-held power tool or an accumulator for a hand-held power tool.

14. A method for testing a memory of an electric tool, the memory having a plurality of memory cells for storing data, a first interface and a second interface independent of the first interface, the memory being coupled via the first interface to a control unit for controlling the electric tool, the method comprising the steps:
coupling a testing module to the memory via the second interface; and
testing the memory cells of the memory via the testing module coupled via the second interface.
